(19) United States
(12) Patent Application Publication
(10) Pub. No.: US 2026/0307035 A1
(43) Pub. Date: Oct. 8, 2026

(54) MICROCAPSULES COMPRISING BIO-BASED PHASE CHANGE MATERIALS

(71) Applicants: Dow Global Technologies LLC, Midland, MI (US); Dow Silicones Corporation, Midland, MI (US)

(72) Inventors: Huhe Chen, Shanghai (CN); Liang Zhang, Shanghai (CN); Ling Zhong, Shanghai (CN); Minbiao Hu, Shanghai (CN)

(21) Appl. No.: 19/482,261

(22) PCT Filed: May 31, 2023
(86) PCT No.: PCT/CN2023/097400

§ 371 Date: Nov. 7, 2025

(51) Int. Cl. B01J 13/16

(52) U.S. Cl. CPC B01J 13/16

(57) ABSTRACT

A composition contains microcapsules showing good thermal stability and comprising a core and a shell, where the core comprises (A) a phase change material component which comprises: (A1) a fatty acid ester, (A2) from 1 to 6 weight percent of a fatty acid having 10 to 18 carbon atoms, based on the weight of the fatty acid ester, and (A3) 0 to 10 weight percent of a fatty alcohol, based on the weight of the fatty acid ester; and where the shell comprises a reaction product of an isocyanate component and an amine compound, where the isocyanate component comprises, based on the weight of the phase change material component, (B1) 1 to 20 weight percent of an aliphatic isocyanate having at least two isocyanate groups, and (B2) 1 to 20 weight percent of an aromatic isocyanate having at least two isocyanate groups; where the weight ratio of the aliphatic isocyanate to the aromatic isocyanate is in a range of from 8.5:1.5 to 1.5:8.5; and where the amine compound comprises at least two amino functional groups selected from a primary amino group, a secondary amino group, or combinations thereof; and wherein the amine compound is present in an amount to provide a molar ratio of total primary and secondary amino groups to isocyanate groups in a range of 0.3:1 to 1.5:1. A method of preparing the composition is also disclosed.

### FIELD

The present invention relates to microcapsules comprising bio-based phase change materials as the core and a method of preparing such microcapsules.

### INTRODUCTION

Phase change materials (PCMs) have been widely used in many applications such as building applications. Before incorporated into a building material matrix, PCMs such as paraffin waxes are usually microencapsulated to avoid leakage by a variety of microcapsule production techniques including such as interfacial polymerization, in-situ polymerization, etc. A typical interfacial polymerization technique for preparation of microcapsules comprising PCMs may involve: forming an oil phase mixture comprising the PCMs as the core materials, an isocyanate, and optionally organic solvents; emulsifying the oil phase mixture by emulsifiers in an aqueous solution under high shear mixing (i.e., mixing at a speed of greater than 1500 revolutions per minute); and then adding the aqueous solution a reactive alcohol or amine, which then reacts with the isocyanate at the interface of two phases to form a polyurethane or a polyurea shell encapsulating the core materials. The emulsification step is critical for successful encapsulation of PCMs using interfacial polymerization. However, the high shear mixing usually results in increases in energy consumption, and equipment and manufacturing costs. Also, aqueous surfactants or colloidal stabilizers are disfavored due to difficult recycling of the reactor effluents and may even adversely impact mechanical properties of the building materials where PCM microcapsules are incorporated. Moreover, the use of solvents causes more environmental problems than aqueous compositions.

Due to their advantages in energy storage density, chemical stability, changes in volume during the phase change process, paraffin waxes are widely used as the core materials of PCM microcapsules. However, paraffin waxes are neither renewable nor biodegradable. It is further desirable to use renewable materials to replace fossil materials, therefore, to reduce emission of greenhouse gas and contribute to sustainability. Bio-based phase change materials can be good candidates. However, it is a challenge for encapsulation of bio-based PCMs that are obtained from plant and animal fats while providing the resultant microcapsules with desired encapsulation performance such as thermal stability and particle size particularly suitable for building applications.

It is desirable to discover a new method of making encapsulated PCMs that comprise bio-based PCMs without the aforementioned problems yet can provide PCMs microcapsules made therefrom with good thermal stability.

### SUMMARY

The present invention solves the problem of discovering a method that is suitable for preparing microencapsulated bio-based phase change materials (PCMs) without the aforementioned problems yet that can form microcapsules particularly suitable for use in building materials.

The present invention provides a composition comprising microcapsules (which is used interchangeable with “microencapsulated PCMs” or “PCM microcapsules”) that comprise a novel combination of at least one fatty acid ester and a specific amount of at least one fatty acid as the core materials and a polyurea shell comprising a reaction product of an amine compound with a mixture of at least one aliphatic isocyanate and at least one aromatic isocyanate. The microcapsules show good thermal stability and compactness, for example, as indicated by a weight loss of less than 20 weight percent, upon heating at 105 degrees Celsius (° C.) for 24 hours (further details provided in the Thermal Stability test described in the Examples section below). Surprisingly, it has been determined such microcapsules can be prepared from a method which involves adding an oil phase mixture comprising the isocyanates and the PCMs into an aqueous amine solution, without requiring the step of emulsification of the oil phase mixture using an emulsifier and/or high shear mixing. Desirably, the method is conducted in the absence of an emulsifier and/or organic solvent, as the oil phase mixture is a self-emulsifying component.

In a first aspect, the present invention is a composition comprising microcapsules comprising a core and a shell,
wherein the core comprises a phase change material component which comprises:
(A1) a fatty acid ester,
(A2) from 1 to 6 weight percent of a fatty acid having 10 to 18 carbon atoms, based on the weight of the fatty acid ester, and
(A3) 0 to 10 weight percent of a fatty alcohol, based on the weight of the fatty acid ester;
wherein the shell comprises a reaction product of an isocyanate component and an amine compound,
wherein the isocyanate component comprises, based on the weight of the phase change material component, (B1) 1 to 20 weight percent of an aliphatic isocyanate having at least two isocyanate groups, and (B2) 1 to 20 weight percent of an aromatic isocyanate having at least two isocyanate groups; wherein the weight ratio of the aliphatic isocyanate to the aromatic isocyanate is in a range of from 8.5:1.5 to 1.5:8.5; and
wherein the amine compound comprises at least two amino functional groups selected from a primary amino group, a secondary amino group, or combinations thereof; and wherein the amine compound is present in an amount to provide a molar ratio of total primary and secondary amino groups to isocyanate groups in a range of 0.3:1 to 1.5:1.

In a second aspect, the present invention is a method of preparing the composition of the first aspect. The method comprises:
(I) providing an oil phase mixture comprising:
(A) a phase change material component comprising:
(A1) a fatty acid ester,
(A2) from 1 to 6 weight percent of a fatty acid having 10 to 18 carbon atoms, based on the weight of the fatty acid ester, and
(A3) 0 to 10 weight percent of a fatty alcohol, based on the weight of the fatty acid ester;
(B) an isocyanate component comprising, based on the weight of the phase change material component, (B1) 1 to 20 weight percent of an aliphatic isocyanate having at least two isocyanate groups, and (B2) 1 to 20 weight percent of an aromatic isocyanate having at least two isocyanate groups; wherein the weight ratio of the aliphatic isocyanate to the aromatic isocyanate is in a range of from 8.5:1.5 to 1.5:8.5;
(II) providing an aqueous amine solution comprising an amine compound and water, wherein the amine compound comprises at least two amino functional groups selected from a primary amino group, a secondary amino group, or combinations thereof; and wherein the amine compound is present in an amount to provide a molar ratio of total primary and secondary amino groups in the amine compound to total isocyanate groups in the isocyanate component in a range of 0.3:1 to 1.5:1;
(III) adding the oil phase mixture to the aqueous amine solution under stirring to form a reaction mixture; and
(IV) maintaining the reaction mixture obtained from step (III) for a period of time until the microcapsules are obtained.

### BRIEF DESCRIPTION OF THE DRAWINGS

FIG. 1 is an optical microscope picture of a dispersion of microcapsules for IE 1 of the present invention described below, taken at room temperature (20-23° C.).

FIG. 2 is an optical microscope picture of a dispersion of microcapsules for IE 3 of the present invention described below, taken at room temperature.

FIG. 3 is a scanning electron microscope (SEM) image of cross section of a microcapsule for IE 3 of the present invention described below.

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ISO refers to International Organization for Standards.

Products identified by their tradename refer to the compositions available under those tradenames on the priority date of this document.

“And/or” means “and, or as an alternative”. All ranges include endpoints unless otherwise indicated.

Unless otherwise stated, all percent (%) values are weight percent relative to composition weight.

“Interfacial polymerization” is a process wherein a microcapsule wall of a polymer such as a polyurea is formed at an interface between two immiscible phases through a polycondensation reaction.

“Phase change materials” refers to substances that are capable of releasing or absorbing energy at phase transition to provide heat or cooling.

“Bio-based phase change materials” (BPCMs) typically refers to phase change materials that are derived from raw materials such as plant, vegetable oils (e.g., soybean oil, coconut oil, and palm oil), animal fat such as beef tallow, animal grease, vegetable wax, or combinations thereof.

“Microencapsulation” refers to a process of encapsulating solid, liquid, or gas materials into micro particles with diameter in a range of 1 micrometer (μm) to 1000 μm.

A microcapsule is a particle having a core surrounded by a shell and having diameter of 1 μm to 1000 μm. The composition of the shell is different from the composition of the core. A shell material is said herein to “surround” a core particle if, when a microcapsule is formed by the combination of the shell material and the core material, the microcapsule contains some volume that is made of the composition of the core particle, and at least 50% or more of the surface area of the microcapsule, based the total area of the surface of the microcapsule, is made of the composition of the shell material.

The present invention relates to a composition comprising microcapsules. The microcapsules comprise a core and a shell (also known as “wall”) that surrounds (or encapsulates) the core. The core of the microcapsules comprises, and can consist of, a phase change material component described below, and optionally inorganic fillers described below. The shell of the microcapsules comprises, and can consist of, a reaction product of an isocyanate component and an amine compound described below, and optionally inorganic fillers described below.

The phase change material component (“PCM component”) useful in the present invention may comprise, and can consist of, a first PCM (A1) one or more fatty acid esters, a second PCM (A2) one or more fatty acids, and optionally, a third PCM (A3) one or more fatty alcohols and/or a fourth PCM (A4) an additional PCM other than (A1), (A2), and (A3), all described herein below.

The fatty acid ester (A1) useful in the present invention is generally produced by esterification reaction of fatty acids with alcohols having one hydroxy (—OH) group, diols, and/or polyols, including, for example, esters of alcohols such as methanol, ethanol, isopropanol, propanol, butanol, isobutanol, pentanol, hexanol, and cyclohexanol; mono-, di- or triglycerides of glycerol, esters of pentaerythritol, polyesters of polyhydric alcohols, esters or diesters of ethylene glycol; or mixtures thereof. Desirably, the fatty acid ester (A1) is one or more fatty acid esters of the alcohols. The fatty acid useful for forming the fatty acid ester (A1) can be a saturated or unsaturated fatty acid having 10 to 18 carbon atoms and one carboxyl functional group (—COOH). Specific examples of fatty acids for preparing the fatty acid ester (A1) include decanoic acid, lauric acid, myristic acid, palmitic acid, oleic acid, stearic acid, hydrates or hydrogenated acids of any of the preceding acids, and/or combinations of two or more thereof.

The fatty acid ester (A1) useful in the present invention may include a fatty acid methyl ester, a fatty acid ethyl ester, a fatty acid propyl ester, a fatty acid butyl ester, or mixtures thereof, desirably, a fatty acid methyl ester, a fatty acid ethyl ester, or combinations thereof, and more desirably, a fatty acid methyl ester. Specific examples of fatty acid esters include methyl palmitate, methyl laurate, methyl stearate, methyl myristate, ethyl laurate, ethyl palmitate, isopropyl stearate, isopropyl palmitate, butyl stearate, butyl palmitate, cetyl palmitate, or mixtures thereof. Desirably, the fatty acid ester (A1) is one or any combination of more than one of the following fatty acid esters: methyl laurate, methyl palmitate, methyl stearate, ethyl laurate, ethyl palmitate, and butyl stearate. Desirably, the fatty acid ester can be methyl palmitate or a mixture of ethyl palmitate and methyl palmitate.

The fatty acid ester (A1) may be present at a concentration of from 86% to 99%, and can be 86% or more, 87% or more, 88% or more, 89% or more, 90% or more, 91% or more, 92% or more, 94% or more, 95% or more, 96% or more, even 96.5% or more while at the same time is 99% or less, and can be 98.5% or less, 98.4% or less, 98% or less, or even 96.5% or less, desirably, from 94% to 99%, by weight based on the weight of the PCM component (A). Weight of the phase change material component also refers to the total weight of PCMs in the microcapsules (e.g., the combined weights of phase change materials (A1), (A2), (A3) and (A4), if present, described below).

The PCM component (A) useful in the present invention comprises (A2) a fatty acid. The fatty acid may comprise a saturated or unsaturated fatty acid having 10 to 18 carbon atoms and one —COOH group. One or more than one of fatty acids can be used. Examples of suitable fatty acids (A2) may include those described above for preparing the fatty acid ester. Particularly suitable examples of fatty acids (A2) include palmitic acid (hexadecanoic acid), lauric acid (dodecanoic acid), stearic acid (octadecanoic acid), myristic acid (tetradecanoic acid), decanoic acid, or mixtures thereof.

The fatty acid (A2) may be present at a concentration of 1.0% to 6.0%, and can be 1.0% or more, 1.2% or more, 1.4% or more, 1.5% or more, 1.6% or more, 2% or more, 2.2% or more, even 2.4% or more while at the same time 6% or less, and can be 5.5% or less, 5% or less, 4.5% or less, 4% or less, 3.5% or less, 3.2% or less, 3% or less, 2.5% or less, or even 2.4% or less, desirably, 1.0% to 3.2% or 1.2% to 2.4%, by weight based on the weight of the fatty acid ester (A1). The concentration of the fatty acid (A2) is critical to both emulsification and polymerization involved in the method of preparing the PCM microcapsules so as to obtain desired particle size distribution and good encapsulation properties (e.g., good thermal stability) described below.

The PCM component (A) useful in the present invention may comprise, or be free of, (A3) a fatty alcohol. The fatty alcohol refers to a straight-chain primary alcohol containing 4 to 26 carbon atoms or 6 to 22 carbon atoms, which may be derived from natural fats and oils. The fatty alcohol may have one hydroxy group. Suitable examples of fatty alcohols may include 1-decanol, 1-dodecanol, 1-tetradecanol, 1-hexadecanol, 1-octadecanol, or mixtures thereof. The fatty alcohol (A3) may be present in an amount of from zero to 10%, and can be zero or more, 0.1% or more, 0.5% or more, 1% or more, 2% or more, 3% or more, even 4% or more while at the same time is 10% or less, and can be 8% or less, 6% or less, 5% or less, 3% or less, 1% or less, 0.5% or less, 0.1% or less, or even zero, desirably, zero to 5% or zero to 3%, by weight based on the weight of the fatty acid ester (A1).

The fatty acid ester (A1), the fatty acid (A2), and the fatty alcohol (A3) described above are bio-based phase change materials and can be derived from renewable sources such as animal fat sources (e.g., pork or beef tallow), poultry fat sources, soybean oil, rapeseed oil, peanut oil, vegetable oil, yellow grease, or combinations of two or more thereof. The concentration of the bio-based PCMs in the PCM component may be in a range of 95% to 100%, and can be 96% or more, 97% or more, 98% or more, 99% or more, or even 100%, by weight based on the weight of the PCM component.

The PCM component (A) useful in the present invention may comprise, desirably be substantially free of, (A4) an additional organic phase change material other than (A1), (A2), and (A3) described above. The additional organic phase change material (A4) may include paraffin hydrocarbons (also known as “straight chain alkanes”) such as N-dodecane, N-tridecane, N-tetradecane, N-pentadecane, N-hexadecane, N-heptadecane, N-octadecane, or mixtures thereof. “Substantially free” means the concentration of the additional organic phase change material (e.g., the paraffin hydrocarbons) is up to 5%, and can be less than 5%, less than 4%, less than 3%, less than 2%, less than 1%, less than 0.1%, or even zero, by weight based on the weight of the PCM component.

Desirably, the PCM component comprises, or consists of, the fatty acid ester (A1) selected from methyl palmitate, methyl laurate, methyl stearate, ethyl laurate, ethyl palmitate, or mixtures thereof; 1.2% to 2.4% of the fatty acid (A2) selected from lauric acid, palmitic acid, or mixtures thereof; and zero to 5.0% of the fatty alcohol (A3), by weight based on the weight of the fatty acid ester.

Desirably, the PCM component is selected from one of the following (a-i) to (a-vi), where:
(a-i) the fatty acid ester (A1) is methyl palmitate, and the fatty acid (A2) is palmitic acid,
(a-ii) the fatty acid ester (A1) is methyl palmitate the fatty acid (A2) is palmitic acid, and the fatty alcohol (A3) is selected from the group consisting of tetradecanol, dodecanol, and mixtures thereof.
(a-iii) the fatty acid ester (A1) is methyl laurate, and the fatty acid (A2) is lauric acid;
(a-iv) the fatty acid ester (A1) is methyl stearate, and the fatty acid (A2) is palmitic acid;
(a-v) the fatty acid ester (A1) is ethyl laurate, and the fatty acid (A2) is lauric acid; and
(a-vi) the fatty acid ester (A1) is a mixture of 10% to 100% of ethyl palmitate and from zero to 90% of methyl palmitate, by weight based on the total weight of the fatty acid ester; and the fatty acid (A2) is palmitic acid.

The core of the PCM microcapsules may comprise bio-based PCMs at a concentration of 95% to 100%, and can be 95% or more, 96% or more, 97% or more, 98% or more, 99% or more, or even 100%, by weight based on the total weight of PCMs in the core.

The shell of the PCM microcapsules of the present invention comprises, or consists of, the reaction product of an isocyanate component and an amine compound, e.g., by a polycondensation reaction between isocyanates in the isocyanate component and the amine compound to form a polyurea through interfacial polymerization. The isocyanate component useful in the present invention comprises a mixture of (B1) one or more aliphatic isocyanates and (B2) one or more aliphatic isocyanates. An “aliphatic isocyanate” refers to an isocyanate containing isocyanate (NCO) groups that are attached to an aliphatic residue. The aliphatic isocyanate (B1) useful in the present invention has at least two NCO groups. The aliphatic isocyanate may have an average NCO functionality of at least 2, and can be 2 or more, 2.5 or more, even 2.7 or more while at the same time is generally 4 or less, and can be 3.5 or less, 3 or less, 2.8 or less, or even 2.7 or less. The aliphatic isocyanate may comprise aliphatic diisocyanates; dimers thereof; trimers thereof; or combinations thereof. The aliphatic diisocyanate may have the structure of X¹ (NCO)₂, where X¹ is a linear or branched alkylene residue that typically has 3 to 16 carbon atoms or 4 to 12 carbon atoms or a cycloalkylene residue that typically has 4 to 18 carbon atoms or 6 to 15 carbon atoms. Examples of suitable aliphatic isocyanates include aliphatic diisocyanates such as tetramethylene diisocyanate, hexamethylene diisocyanate (HDI), cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, 1, 12-dodecane diisocyanate, 2-methyl-1,5-pentamethylene diisocyanate; 4-isocyanatomethyl-1, 8-octane diisocyanate (TIN), decane diisocyanate, undecane diisocyanate and dodecane diisocyanate, isophorone diisocyanate (IPDI), dicyclohexyl methane diisocyanate (HMDI), 1,4-cyclohexane diisocyanate, and 1, 3-bis (isocyanato methyl)cyclohexane; diisocyanatodicyclohexylmethane (H₁₂MDI), 2-methylpentane diisocyanate (MPDI), 2, 2, 4-trimethylhexamethylene diisocyanate/2, 4, 4-trimethylhexamethylene diisocyanate (TMDI), norbornane diisocyanate (NBDI); xylylene diisocyanate (XDI), tetramethylxylylene diisocyanate; dimers of these aliphatic diisocyanates; trimers of these aliphatic diisocyanates such as HDI trimer; homopolymers thereof such as HDI homopolymers and IPDI homopolymers; adducts such as isophorone diisocyanate adducts, or mixtures thereof. A mixture of two or more aliphatic isocyanates can be used provided that the average functionality of these aliphatic isocyanate is 2 or higher. Desirably, the aliphatic isocyanate is selected from the group consisting of IPDI, HDI, HDI trimer, IPDI trimer, and mixtures thereof.

The aliphatic isocyanate may be present in an amount of from 1% to 20%, and can be 1% or more, 3% or more, 5% or more, 6% or more, 7% or more, 8% or more, 9% or more, while at the same time is 20% or less, 18% or less, 15% or less, 14% or less, 12% or less, or even 10% or less, by weight based on the weight of the PCM component.

The aromatic isocyanate (B2) useful in the present invention contains at least two NCO groups. The aromatic isocyanate may have an average NCO functionality of at least 2, and can be 2 or more, 2.5 or more, even 2.7 or more while at the same time is generally 4 or less, and can be 3.5 or less, 3 or less, 2.8 or less, or even 2.7 or less. The aromatic isocyanate may comprise aromatic diisocyanates of the structure of X² (NCO)₂, where X² is an aromatic hydrocarbon radical having from 6 to 15 carbon atoms; dimers thereof; trimers thereof; or combinations thereof. Examples of suitable aromatic isocyanates include diphenylmethane diisocyanate (MDI) such as 2, 2′-MDI, 2, 4′-MDI, 4, 4′-MDI, or mixtures thereof; 1, 3- and 1, 4-phenylene diisocyanate, 1,5-naphthylene diisocyanate, toluene diisocyanate (TDI) including such as 2, 6-TDI, 2, 4-TDI, or mixtures thereof, 3, 3′-Dimethyl-4, 4′-Biphenyldiisocyanate (TODI), phenylene diisocyanate; carbodiimide-modified diphenylmethane diisocyanate including carbodiimide-modified isomers of MDI described above such as carbodiimide-modified 4, 4′-MDI, polycarbodiimide-modified diphenylmethane diisocyanate; polymeric derivatives of the monomeric diisocyanate described above, such as polymeric methylene diphenyl diisocyanate (“polymeric MDI”) including a polymethylene polyphenylisocyanate; or combinations thereof. A mixture of 2, 4′-MDI and 4, 4′-MDI may be used. Suitable commercially available carbodiimide-modified MDI may include ISONATE™ 143L polycarbodiimide-modified MDI available from The Dow Chemical Company (ISONATE is a trademark of The Dow Chemical Company. Polymeric MDI may be a mixture of diphenylmethane diisocyanate and polymethylene polyphenylisocyanate.

A mixture of two or more aromatic isocyanates can be used provided that the average functionality of these aromatic isocyanate is 2 or higher. Desirably, the aromatic isocyanate (B2) is selected from the group consisting of a polymethylene polyphenylisocyanate, methylene diphenyl diisocyanate, a polycarbodiimide-modified MDI, and mixtures thereof. The polymethylene polyphenylisocyanate useful in the present invention may have an average NCO functionality of 2 to 4, and can be 2 or more, 2.2 or more, 2.3 or more, even 2.5 or more while at the same time is 4 or less, and can be 3.5 or less, 3 or less, 2.8 or less, or even 2.7 or less. The polymethylene polyphenylisocyanate may have a number average molecular weight of 250 to 400, and can be 250 or more, 270 or more, even 290 or more while at the same time is 400 or less, and can be 380 or less, or even 360 or less, as measured by gel permeation chromatography (GPC). Suitable commercially available polymethylene polyphenylisocyanates include PAPI™ PB-219, PAPI 27, PAPI 20, PAPI 580N, VORANATE™ M229, VORANATE M220, VORANATE 290, VORANATE M595 and VORANATE M600 isocyanates, all available from The Dow Chemical Company (PAPI and VORANATE are trademarks of The Dow Chemical Company).

A prepolymer of the monomeric aliphatic or aromatic isocyanate described above, comprising at least two isocyanate groups (which is used interchangeable with “isocyanate prepolymer”) can be used. The isocyanate prepolymer can be obtained by reacting the above described monomeric isocyanate with an isocyanate-reactive compound known in the art. The isocyanate prepolymer may have an average NCO functionality of 3 or more.

The aromatic isocyanate (B2) may be present in an amount of from 1% to 20%, and can be 1% or more, 3% or more, 5% or more, 6% or more, 7% or more, 8% or more, 9% or more, while at the same time is 20% or less, and can be 18% or less, 15% or less, 14% or less, 12% or less, or even 10% or less, by weight based on the weight of the PCM component.

The aliphatic isocyanate (B1) and the aromatic isocyanate (B2) can be in amounts to provide a weight ratio of the aliphatic isocyanate to the aromatic isocyanate (also referred to as “B1/B2 ratio”) in a range of from 8.5:1.5 to 1.5:8.5, from 7:3 to 3:7, from 6:4 to 4:6, from 5:5 to 3:7, or even from 4:6 to 5:5, desirably, in a range of from 4:6 to 5:5.

Desirably, the isocyanate component (B) useful in the present invention comprises one of the following (b-i) to (b-iii):
(b-i) a mixture of IPDI and a polymethylene polyphenylisocyanate at a weight ratio of IPDI to polymethylene polyphenyl isocyanate in a range of from 3:7 to 7:3, desirably, from 4:6 to 6:4, and more desirably, from 4:6 to 5:5;
(b-ii) a mixture of HDI trimer and a polymethylene polyphenylisocyanate at a weight ratio of HDI trimer to polymethylene polyphenyl isocyanate in a range of 3:7 to 7:3, desirably, from 4:6 to 6:4, and more desirably, from 4:6 to 5:5; and
(b-iii) a mixture of IPDI trimer and a polymethylene polyphenylisocyanate at a weight ratio of HDI trimer to polymethylene polyphenyl isocyanate in a range of 3:7 to 7:3, desirably, from 4:6 to 6:4, and more desirably, from 4:6 to 5:5.

The amine compound useful in the present invention have at least two, or three, amino functional groups selected from a primary amino group (—NH₂), a secondary amino group (—NH—), or combinations thereof. The amine compound may comprise two or more —NH₂ groups, two or more —NH-groups, or a combination of at least one —NH₂ group with at least one —NH-group. The amine compound is useful as a hardener and typically contains up to 8 carbon atoms, thus usually a water-soluble amine. The amine compound usually has a molecular weight of from 32 to 500 grams per mole (g/mol) or from 60 to 300 g/mol. The amine compound may be an aromatic polyamine, an aliphatic polyamine, or mixtures thereof. “Aromatic polyamine” refers to an organic compound containing an aromatic ring attached to an amine. Examples of suitable aromatic polyamines include 2, 4- and/or 2, 6-toluene diamine (TDA), 4, 4′-, 2, 4′- and 2, 2′-diaminodiphenylmethane (MDA), or mixtures thereof. “Aliphatic polyamine” refers to a polyamine containing two or more primary or secondary amino groups separated by an aliphatic hydrocarbon chain that can be linear or branched. Desirably, the amine compound comprises or consists of one or more aliphatic polyamines. Examples of suitable aliphatic polyamines include diamines such as diaminoethane, diaminopropanes, diaminobutanes, diaminohexanes such as 1, 6-diaminohexane and trimethylhexane diamine, amino-3-aminomethyl-3, 5, 5-trimethylcyclohexane (isophoronediamine, IPDA), 2, 4- or 2, 6-diamine-1-methylecyclohexane, 1, 3- and/or 1, 4-bis (aminomethyl)cyclohexane, 4, 4′-diaminodicyclohexylmethane, 1, 4-diaminocyclohexane, piperazine, 2, 5-dimethylpiperazine, triamines such as diethylenetriamine (DETA), 1, 3, 5-cyclohexanetriamine, 1, 2, 3-propanetriamine, and 1, 8-diamino-4-aminomethyloctane; triethylenetetramine, tetraethylenepentamine, pentaethylenehexamine; or mixtures thereof. Desirably, the amine compound is a triamine. More desirably, the amine compound is selected from the group consisting of DETA, 1, 3, 5-cyclohexanetriamine, 1, 2, 3-propanetriamine, or mixtures thereof.

The amine compounds are present in an amount sufficient to provide a molar ratio of total primary and secondary amino groups in the amine compound to total-NCO groups in the isocyanate component (hereinafter also refer to “Amino/NCO ratio”) in a range of 0.3:1 to 1.5:1, and can be 0.3:1 or more, 0.4:1 or more, 0.5:1 or more, 0.7:1 or more, 0.8:1 or more, 0.9:1 or more, even 1:1 while at the same time is 1:5:1 or less, and can be 1.4:1 or less, 1.3:1 or less, 1.2:1 or less, 1.1:1 or less, or even 1:1 or less, desirably, 0.9:1 to 1:1.1.

The shell of the microcapsules may also comprise a reaction product of the isocyanates with water, particularly when the Amino/NCO ratio is less than 1. The core and/or the shell of the microcapsules may independently comprise, or be free of, one or more inorganic fillers. Suitable inorganic fillers may include, for example, natural calcium carbonates, including chalks, calcites and marbles, synthetic carbonates, salts of magnesium and calcium, dolomites, magnesium carbonate, zinc carbonate, lime, magnesia, barium sulphate, barite, calcium sulphate, silica, magnesium silicates, talc, wollastonite, clays and aluminum silicates, kaolins, mica, oxides or hydroxides of metals or alkaline earths, magnesium hydroxide, iron oxides, zinc oxide, glass or carbon fiber or powder, or powder or mixtures of these compounds. Desirably, the inorganic fillers include CaCO₃, talc, mica, SiO₂, TiO₂, kaolin, coal gangue powders, sepiolite powders, attapulgite powders, montmorillonite, or mixtures thereof. The inorganic fillers in the PCM microcapsules may be present at a total concentration of from zero to 30%, and can be zero or more, 2% or more, 5% or more, 8% or more, 10% or more, 12% or more, even 15% or more while at the same time is 30% or less, and can be 28% or less, 25% or less, 22% or less, 20% or less, or even 18% or less, desirably, 2% to 30%, 5% to 20%, or 8% to 15%, by weight based on the weight of the PCM component.

The microcapsules of the present invention may comprise or be free of an emulsifier (described below in the method section). The concentration of the emulsifier may be less than 0.1%, and can be 0.05% or less, 0.001% or less, or even zero, by weight based on the weight of the microcapsules.

The microcapsules of the present invention may have an average weight ratio of core to shell (hereinafter also referred to as “core/shell ratio”) in a range of from 2.0:1 to 10:1, from 3.0:1 to 9:1, from 3.5:1 to 8:1, from 4.0:1 to 7:1, from 4.0:1 to 6.2:1, from 4.0:1 to 5.5:1, desirably, from 4.0:1 to 5.0:1. The core/shell ratio can be determined using differential scanning calorimetry (DSC), such as by analyzing the thermal enthalpy of the PCM microcapsules using DSC-Q2000 (TA Instruments) at 1 to 10° C. per minute (° C./min) for heating and cooling between 0 to 60° C.

The microcapsules of the present invention may have a D90 particle size in a range of from 10 micrometers (μm) to 500 μm, and can be 10 μm or more, 20 μm or more, 30 μm or more, 50 μm or more, 60 μm or more, 80 μm or more, 90 μm or more, even 100 μm or more while at the same time can have a D90 of 500 μm or less, and can be 400 μm or less, 300 μm or less, 250 μm or less, 220 μm or less, or even 200 μm or less, desirably, from 30 μm to 250 μm. The microcapsules of the present invention may have a D10 particle size in a range of from 1 μm to 50 μm, and can be 1 μm or more, 2 μm or more, 3 μm or more, 5 μm or more, 6 μm or more, 8 μm or more, 9 μm or more, even 10 μm or more while at the same time can have a D10 of 50 μm or less, and can be 40 μm or less, 30 μm or less, 25 μm or less, 22 μm or less, or even 20 μm or less, desirably, from 5 μm to 30 μm. D10 and D90 refer to volume-based particle size distributions, representing the particle diameter corresponding to 10% and 90% of the distribution lies below this diameter, respectively, which may be measured according to Focused Beam Reflectance Measurement technology (further details are provided in the Examples section below).

The microcapsules of the present invention may comprise multiple different phases or layers, which are formed by the PCMs and the reaction product of the amine compound and the isocyanate component. The microcapsules have a core-shell structure. The structure of the PCM microcapsules can be characterized by SEM. FIG. 3 is a representative SEM image of cross sections of the PCM microcapsules of the present invention (IE 3 described below), indicating core-shell structure of the microcapsules.

The composition of the present invention can be an aqueous dispersion or powders, comprising the microcapsules. The composition comprising the microcapsules demonstrate good thermal stability, indicating good encapsulation compactness. “Good thermal stability” means the composition, upon heating at 105° C. for 24 hours (hereinafter also referred to as “thermal aging”), shows a weight loss of less than 20%, desirably, less than 10%, less than 9%, less than 8%, less than 7%, less than 6%, more desirably, less than 5%, by weight relative to the weight of the microcapsules (prior to the thermal aging), as measured according to the Thermal Stability of Microcapsules test described in the Examples section below.

The method of preparing the composition of the microcapsules of the present invention may comprise the steps of: (I) providing an oil phase mixture, (II) providing an aqueous amine solution, (III) adding the oil phase mixture into the aqueous amine solution under stirring, and (IV) maintaining the reaction mixture for a period of time until the microcapsules are obtained.

The oil phase mixture useful in the present invention may comprise the PCM component (A) described above, the isocyanate component (B) described above, and optionally the inorganic filler described above. The oil phase mixture may comprise or be free of the inorganic filler described above. In step (I), the oil phase mixture may be prepared by admixing the PCM component (e.g., (A1), (A2), and optionally (A3) and (A4)) with the isocyanate component (B), and optionally, the inorganic filler. Desirably, the PCM component is first subject to an elevated temperature sufficient to melt the PCMs (such as methyl palmitate, ethyl palmitate, and palmitic acid), prior to addition of the rest components in the oil phase mixture. The temperature for melting the PCMs may be in a range of from 30 to 70° C., depending on melting points of the PCMs. Desirably, the temperature of the oil phase mixture in step (I) is in a range of 40 to 60° C. When used, the inorganic filler may be included into the oil phase mixture in step (I). When the inorganic filler is used, the oil phase mixture may further comprise one or more dispersants. Desirably, the oil phase mixture comprises a blend of one of the PCM component (a-i) through (a-vi) described above with the isocyanate component (b-i) described above, a blend of one of the PCM component (a-i) through (a-vi) with the isocyanate component (b-ii) described above, or a blend of one of the PCM component (a-i) through (a-vi) with the isocyanate component (b-iii) described above; where each blend may comprise, or be free of, the inorganic filler described above. The concentration of each component in the oil phase mixtures is the same as described in the PCM microcapsules section.

The aqueous amine solution useful in the present invention comprises the amine compound described above and water. The amount of the amine compound used is to provide the same Amino/NCO ratios as described in the PCM microcapsules section above. Water in the aqueous amine solution is typically present in an amount sufficient to provide an aqueous phase containing the amine compound that reacts with the isocyanates in the oil phase and to control the viscosity of the mixture of the aqueous amine solution and oil phase mixture so as to give the resultant microcapsules with desirable particle size distribution. For example, water may be present in an amount of at least 3 times and can be 3.1 times or more, 3.2 times or more, 3.3 times or more, 3.4 times or more, or even 4 times or more, of the total weight of the oil phase mixture. In step (II) of the method, the aqueous amine solution can be prepared by admixing the amine compound with water. The aqueous amine solution may be further heated to temperatures ranging from 30 to 80° C., and can be from 40 to 70° C. or from 50 to 70° C., prior to the addition of the oil phase mixture. Desirably, the temperature of the aqueous amine solution in step (II) is in a range of 50 to 70° C.

The oil phase mixture and/or the aqueous amine solution used for preparing the PCMs microcapsules may be substantially free of an emulsifier. Surprisingly, the use of the specific amount of the fatty acid (A2) described above in combination with the fatty acid ester (A1) provides a self-emulsifying PCM component, which is essential to good encapsulation of PCMs using the method of the present invention. The emulsifier may be cationic, anionic, or nonionic. Examples of the emulsifiers include nonionic surfactants such as secondary alcohol ethoxylates, sulfates of ethoxylated phenols such as poly (oxy-1, 2-ethanediyl), α-sulfo-ω-(nonylphenoxy) salt; alkali metal fatty acid salts such as alkali metal oleates, alkali metal stearates, alkali metal paltimates; alkali metal C₁₂-C₁₆ alkyl sulfates such as alkali metal lauryl sulfates; amine C₁₂-C₁₆ alkyl sulfates such as amine lauryl sulfates, more desirably triethanolamine lauryl sulfate; alkali metal C₁₂-C₁₆ alkylbenzene sulfonates such as branched and linear sodium dodecylbenzene sulfonates; amine C₁₂-C₁₆alkyl benzene sulfonates such as triethanolamine dodecylbenzene sulfonate; anionic and nonionic fluorocarbon emulsifiers such as fluorinated C₄-C₁₆ alkyl esters and alkali metal C₄-C₁₈ perfluoroalkyl sulfonates; organosilicon emulsifiers such as modified polydimethylsiloxanes. “Substantially free” refers to less than 0.1%, and can be 0.05% or less, 0.001% or less, or even zero, by weight based on the total solids weight of the oil phase mixture and the aqueous amine solution.

In step (III) of the method, adding the oil phase mixture into the aqueous amine solution under stirring to form a reaction mixture. The oil phase mixture may be added at a temperature in a range of from 30 to 80° C., from 10 to 75° C., from 20 to 70° C., from 30 to 70° C., or even from 40 to 70° C. The aqueous amine solution can be at a temperature in a range of from 30 to 80° C., from 40 to 70° C., even from 50 to 70° C. while the oil phase mixture is added. Desirably, when (A1) the fatty acid ester is methyl palmitate, ethyl palmitate, or a mixture thereof, the oil phase mixture is added at a temperature of 50 to 70° C. to the aqueous amine solution while the aqueous amine solution is at a temperature of 50 to 70° C.

In step (IV) of the method, maintaining the reaction mixture at a temperature typically in a range of from 30 to 80° C., from 40 to 70° C., or from 50 to 70° C., for a period of time until the microcapsules are obtained. The time needs to be sufficient to complete the interfacial polymerization, for example, in a range of from 0.1 hour to 5 hours, from 0.5 hour to 4 hours, or from 1 hour to 3 hours. After the reaction, the resulting aqueous dispersion of the microcapsules can be cooled down to room temperature. “Aqueous” dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, or mixtures thereof. The obtained aqueous dispersion may have a solids content in a range of from 5% to 60%, from 10% to 50%, or from 20% to 40%, by weight based on the weight of the aqueous dispersion.

One, two or more, or all of the above steps (I) to (IV) in the method, particularly step (III), can be conducted with the standard power-mixing provided by an overhead mixer with 3 centimeter agitation blade at a low speed, that is, lower than 1500 revolutions per minute (rpm), and can be from 100 to 1400 rpm, from 200 to 1000 rpm, less than 1000 rpm, or from 300 to 700 rpm.

The method of the present invention may further comprise (V) drying the aqueous dispersion of microcapsules to give powders of the microcapsules (i.e., solid microcapsules). Drying can be conducted by spray drying. Desirably, the aqueous dispersion obtained from step (IV) is filtered to give pastes of the microcapsules, which are further subject to drying. The filtration step also gives a filtrate which can be recycled to step (III) as the oil phase mixture and the aqueous amine solution can be substantially free of the emulsifier.

The method of the present invention does not require, desirably, is in the absence of, a pre-emulsified step prior to step (III). The pre-emulsified step herein refers to any approach that can emulsify the oil phase mixture, for example, using the emulsifier described above and/or with the aid of high shear mixing (i.e., mixing at a mixing speed of greater than 1500 rpm). The method of the present invention provides a self-emulsifying approach for microencapsulating the PCMs.

The oil phase mixture and the aqueous amine solution used in the method may be substantially free of organic solvents. Due to substantial absence of the solvent, the method of preparing the microencapsulated PCMs does not involve (that is, is free of) an extra procedure for removal of the solvent, e.g., stripping off the solvent.

The composition comprising the microcapsules obtained from the method can be used in many applications including building and construction, beddings, textiles, foams, automotives, heating, ventilation, and air conditioning (HVAC), and batteries and electronics.

### EXAMPLES

Some embodiments of the invention will now be described in the following Examples, wherein wt % refers to weight percent relative to the weight of a composition, unless otherwise specified. Table 1 lists the materials for use in microencapsulation of phase change materials (PCMs) described herein below. Note: PAPI, ISONATE, and TERGITOL are trademarks of The Dow Chemical Company.

TABLE 1

| Component | Description | Source |
|---|---|---|
| PCM (A1) | Methyl palmitate (CH₃(CH₂)₁₄CO₂CH₃) | Available from KLK OLEO |
| | Methyl laurate (CH₃(CH₂)₁₀CO₂CH₃) | Available from Sinopharm |
| | Methyl stearate (CH₃(CH₂)₁₆CO₂CH₃) | Chemical Reagent Co., Ltd. |
| | Ethyl laurate | |
| | Ethyl palmitate | |
| PCM (A3) | Decanol | Available from Sinopharm |
| | Dodecanol | Chemical Reagent Co., Ltd. |
| | Tetradecanol | |
| PCM (A2) | Palmitic acid | Available from Sinopharm |
| | Lauric acid | Chemical Reagent Co., Ltd. |
| Aliphatic | Isophorone diisocyanate having an average NCO | Available from Sinopharm |
| Isocyanate (B1)-1 | functionality of 2.0 and a NCO content of 37.5-37.8 | Chemical Reagent Co., Ltd. |
| | wt % (“IPDI”) | |
| Aromatic | A polymethylene polyphenylisocyanate that contains | Available from The Dow |
| Isocyanate (B2)-1 | MDI, having an average NCO functionality of 2.7 | Chemical Company under the |
| | and a NCO content of 31.4 wt % (“Polymeric MDI”) | name PAPI ™ 27 |
| Aliphatic | 1,6-Hexamethylene diisocyanate trimer having an | Available from Wanhua |
| Isocyanate (B1)-2 | average NCO functionality of 3.0 and a NCO content | Chemical Group under the |
| | of 21.8 wt % (“HDI trimer”) | name WANNATE ™ HT-100 |
| Filler | CaCO₃ 1200 mesh (“CC-1200”) | Available from Sinopharm |
| | | Chemical Reagent Co., Ltd. |
| Hardener | Diethylenetriamine (“DETA”) | Available from The Dow |
| | | Chemical Company |
| Surfactant | A secondary alcohol ethoxylate nonionic surfactant | Available from The Dow |
| | (“15-S-5”) | Chemical Company under the |
| | | name TERGITOL ™ 15-S-5 |
| | A secondary alcohol ethoxylate nonionic surfactant | Available from The Dow |
| | (“15-S-9”) | Chemical Company under the |
| | | name TERGITOL ™ 15-S-9 |
| | An anionic sodium dodecylbenzene sulfonate | Available from Sinopharm |
| | surfactant (“SDBS”) | Chemical Reagent Co., Ltd. |
| | Ammonium palmitate | |
| | Sodium palmitate | |

NCO content refers to weight percent of NCO groups relative to the weight of an isocyanate compound, as measured according to ISO 14896 Polyurethane Raw Materials-Determination of Isocyanate Content.

### Inventive Examples (IEs) 1-14 and Comparative Examples (CEs) 1-15 Samples

Formulations for these samples are in Tables 2 and 3, with the amount of each component reported in grams (g). Samples were prepared by using a SFJ 400 Multi-Functional Lab Mixer equipped with a hot water circulating bath to mix the components together.

### General Procedure for Sample Preparation

Firstly, PCMs (A1), (A2), and (A3) if used were placed into an oven at 50-70° C. to melt to give melted PCMs (“pre-melting step”). Then other components in the oil phase mixture (including the isocyanates (B1) and (B2), surfactant, and the filler, if used) were added into the melted PCMs obtained above, thereby forming a hot oil phase mixture. Notably, when preparing IE 8, IE 10, CE 12, and CE 13 samples, respectively, the step of pre-melting PCMs was omitted, and the oil phase mixture was prepared by admixing all components in the oil phase mixture.

Secondly, DETA, deionized (DI) water, and surfactant if used were mixed to form an aqueous amine solution (also as “DETA solution”) and then heated to 50-70° C.

The oil phase mixture obtained above was directly poured into the aqueous amine solution obtained above with stirring at a mixing speed of 200-700 revolutions per minutes (rpm). The resulting reaction mixture was kept at 50-70° C. for 1-4 hours and then cooled down to room temperature to give an aqueous dispersion of PCM microcapsules. The aqueous dispersion of microcapsules was filtered using a filter paper with 3-5 μm pores to give pastes of microcapsules that further dried at 50° C. overnight to obtain powders of microcapsules.

The aqueous dispersion of microcapsules obtained above was evaluated for particle size distribution analysis and the powders of microcapsules obtained above were used for thermal stability evaluation, according to the following test methods:

### Particle Size and Distribution of Microcapsules

Particle size and particle size distribution of PCM microcapsules in a dispersion sample were analyzed using ParticleTrack™ G400 with FBRM™ (Focused Beam Reflectance Measurement) technology. The ParticleTrack G400 system includes the base unit and probe connected by a flexible armored conduit. The measurement range is 0.5 to 2000 μm.

The dispersion sample was placed in a beaker and kept under stirring (200-250 rpm) during the particle size measurement. Insert a 14 millimeters (mm) probe vertically into the dispersion sample and start the measurement. Run the test for 3-5 minutes for each sample. Results of D10 and D90 are given at the end of the measurement.

### Thermal Stability of Microcapsules

Approximate 1 gram sample of powders of PCM microcapsules was weighed using analytical balance (recorded as “W1”) and placed in a Thermo Scientific Heratherm OMH60 advanced lab oven. Set the oven temperature to 105° C. Put the sample into the oven for thermal aging at 105° C. for 24 hours. Weigh the sample again after the thermal aging, recorded as “W2”. The weight loss of the sample can be calculated as (W1−W2)/W1. A weight loss of less than 20% after the thermal aging means good thermal stability, indicating good compactness. Notably, in some CEs samples, agglomerates, big lumps, and/or gels were observed by the naked eye, so thermal stability properties of these samples were not measured, thus reporting as “NA”.

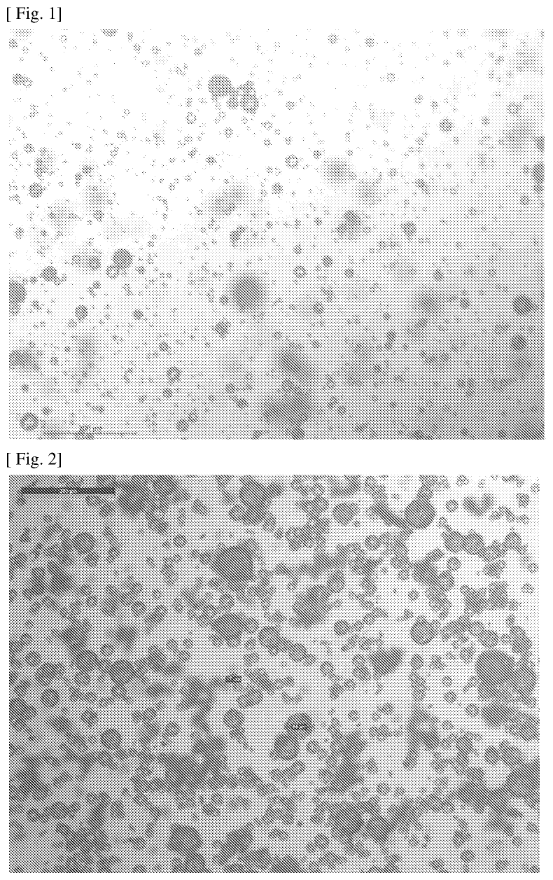

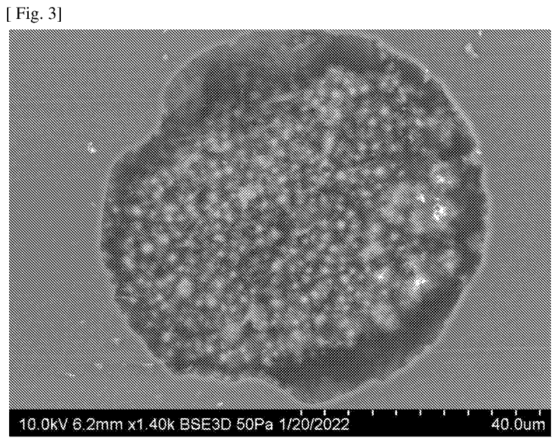

As shown in Table 2, all IEs 1-14 provided good encapsulation of PCMs and the resultant PCM microcapsules all met the requirement of good thermal stability (i.e., a weight loss of less than 20% after the thermal aging). For all IEs, when an oil phase mixture comprising the fatty acid ester (A1), the fatty acid (A2), the isocyanates (B1) and (B2), and optionally, the fatty alcohol (A3) and/or inorganic fillers within claimed amounts was added into the aqueous DETA solution, well-dispersed dispersions (no grits) were obtained. In IEs 1 to 4, polymeric MDI and IPDI were used together as the isocyanates and the resultant microcapsules all met the thermal stability requirement. IE 5 microcapsules with a lower core/shell ratio (4:1) showed further improved thermal stability than IE 4 (core/shell ratio=5:1). IE 6 microcapsules free of inorganic fillers also showed a bit better thermal stability than IE 3. IE 7 using a mixture of MDI and HDI trimer as the isocyanate component and methyl palmitate combining with palmitic acid as the PCM component provided even better thermal stability than IEs 1-4, indicating the combination of trifunctional HDI trimer and polymeric MDI may contribute to form more compact shell than the use difunctional IPDI and polymeric MDI. IE 9 using methyl stearate combining with palmitic acid formed the PCM core for the microcapsules. By blended with lauric acid, methyl laurate and ethyl laurate in IEs 8 and 10, respectively, can be emulsified and encapsulated based on the same process as IE 7. Thus, methyl laurate and ethyl laurate, respectively, combining with lauric acid formed the PCM core for microcapsules formed in IE 8 and IE 10. In IE 11, by blended with palmitic acid, ethyl palmitate can be emulsified and encapsulated based on the same process as IE 7. In IE 12, methyl palmitate was partially replaced with ethyl palmitate and blended with palmitic acid, forming the PCM core of the resultant microcapsules. By blended with palmitic acid, the methyl palmitate-ethyl palmitate binary ester can be emulsified and encapsulated to form the core of the resultant microcapsules of IE 12. By addition of palmitic acid, a blend of methyl palmitate with a low level of fatty alcohol (i.e., ratio of methyl palmitate to tetradecanol is 96:4 by mass) was well encapsulated, together forming the core of the resultant microcapsules of IE 13. IE 14 with an amino/NCO molar ratio of 0.5 provided microcapsules with the required thermal stability. All the aqueous dispersions of microcapsules obtained in IEs 1-14 were observed with an optical microscope, which confirms microcapsule particles were formed for all IEs. FIGS. 1 and 2 are representative optical microscope pictures for IE 1 and IE 3, respectively. Some of these aqueous dispersions of microcapsules of IEs were further evaluated according to the particle size distribution test described above and results are given in Table 2.

As shown in Table 3, adding a blend of methyl palmitate and the isocyanates (B1) and (B2) into the aqueous DETA solution failed to form an emulsion in CE 1. In CEs 2 and 3, each oil phase mixture was prepared by only mixing a nonionic secondary alcohol ethoxylate surfactant, methyl palmitate, and the isocyanates (B1) and (B2). Adding such oil phase mixture into the DETA aqueous solution formed an emulsion, which, after filtering, gave sticky, thick lumps, indicating a substantial amount of methyl palmitate was not encapsulated. As compared to CE 3, CE 4 further incorporated non-ionic and anionic surfactants (15-S-5 and SDBS) into the DETA-containing aqueous phase first, followed by addition of the oil phase mixture under mixing. CE 4 failed to obtain an emulsion but formed big lumps. In CE 5 and CE 6, sodium palmitate and ammonium palmitate were added into the aqueous DETA solution, respectively, and then the oil phase mixture consisting of methyl palmitate, isocyanates, and the filler was further added into the aqueous solution obtained above with stirring. Methyl palmitate was not emulsified, and big aggregates were formed in both CEs 5 and 6. Microcapsules obtained in CEs 7-9 and 11 all showed a weight loss of more than 20% after the thermal ageing, indicated poor encapsulation. CEs 7 and 8 incorporated lower concentrations of palmitic acid than the claimed amount into methyl palmitate. Methyl palmitate could not be emulsified, and big aggregates were formed in CE 7. CE 8 gave an emulsion but provided poor encapsulation and could not meet the thermal stability requirement. When incorporating palmitic acid at a higher concentration than the claimed amount into the oil phase mixture in CE 9, the PCMs were poorly encapsulated and failed to meet the thermal stability requirement. CE 10 using IPDI as the sole isocyanate (no aromatic isocyanate was used) failed to encapsulate the PCMs and only big lumps were obtained. In CE 11, polymeric MDI was used alone without the use of an aliphatic isocyanate, PCM microcapsules were obtained but showed poor thermal stability. In CEs 12 to 15, decanol, dodecanol, tetradecanol, and octadecane were used to replace methyl palmitate, respectively, but none of them can be encapsulated. When the oil phase mixture was added into the aqueous DETA solution, viscous gel-like samples were obtained for all CEs 12 to 15.

TABLE 2
Compositions and characterization results of IE 1 to IE 14

| Component | IE 1 | IE 2 | IE 3 | IE 4 | IE 5 | IE 6 | IE 7 |
|---|---|---|---|---|---|---|---|
| Oil phase mixture | | | | | | | |
| Methyl palmitate | 100.0 | 100.0 | 100.0 | 100.0 | 100.0 | 100.0 | 100.0 |
| Methyl laurate | | | | | | | |
| Methyl stearate | | | | | | | |
| Ethyl laurate | | | | | | | |
| Ethyl palmitate | | | | | | | |
| Tetradecanol | | | | | | | |
| IPDI | 6.3 | 6.3 | 6.3 | 7.6 | 9.5 | 6.3 | |
| Polymeric MDI | 6.3 | 6.3 | 6.3 | 7.6 | 9.5 | 6.3 | 12.2 |
| HDI trimer | | | | | | | 2.6 |
| CC-1200 | 20.0 | 20.0 | 20.0 | 20.0 | 20.0 | | 10.0 |
| Palmitic acid | 3.2 | 2.4 | 1.6 | 1.6 | 1.6 | 1.6 | 1.6 |
| Lauric acid | | | | | | | |
| Aqueous amine solution | | | | | | | |
| DI Water | 600.0 | 600.0 | 600.0 | 600.0. | 600.0 | 600.0 | 600.0 |
| DETA | 4.0 | 4.0 | 4.0 | 4.9 | 6.1 | 4.0 | 4.0 |
| Characterization | | | | | | | |
| Solids content, % | 18.9 | 18.4 | 18.3 | 19.1 | 19.6 | 16.4 | 17.3 |
| Core/shell ratio | 6.2:1 | 6.2:1 | 6.1:1 | 5.0:1 | 4.0:1 | 6.0:1 | 5.5:1 |
| Wt % Fatty acid | 3.2 | 2.4 | 1.6 | 1.6 | 1.6 | 1.6 | 1.6 |
| B1/B2 ratio | 5:5 | 5:5 | 5:5 | 5:5 | 5:5 | 5:5 | 1.8:8.2 |
| D10, μm | 26.5 | 18.9 | 26.9 | NA | NA | NA | 40.2 |
| D90, μm | 146.2 | 102.7 | 139.4 | NA | NA | NA | 255.7 |
| Wt % Loss (105° C., 24 h) | 18.9 | 14.6 | 16.5 | 10.4 | 6.9 | 12.6 | 9.3 |
| Component | IE 8 | IE 9 | IE 10 | IE 11 | IE 12 | IE 13 | IE 14 |
| Oil phase mixture | | | | | | | |
| Methyl palmitate | | | | | 90.0 | 96.0 | 100.0 |
| Methyl laurate | 100.0 | | | | | | |
| Methyl stearate | | 100.0 | | | | | |
| Ethyl laurate | | | 100.0 | | | | |
| Ethyl palmitate | | | | 100.0 | 10.0 | | |
| Tetradecanol | | | | | | 4.0 | |
| IPDI | | | | | | | |
| Polymeric MDI | 9.0 | 9.0 | 9.0 | 9.0 | 9.0 | 9.0 | 9.0 |
| HDI trimer | 7.0 | 7.0 | 7.0 | 7.0 | 7.0 | 7.0 | 7.0 |
| CC-1200 | 20.0 | 20.0 | 20.0 | 20.0 | 20.0 | 20.0 | 10.0 |
| Palmitic acid | | 1.6 | | 1.6 | 1.6 | 1.6 | 1.6 |
| Lauric acid | 1.6 | | 1.6 | | | | |
| Aqueous amine solution | | | | | | | |
| DI Water | 600.0 | 600.0 | 600.0 | 600.0 | 600.0 | 600.0 | 600.0 |
| DETA | 4.0 | 4.0 | 4.0 | 4.0 | 4.0 | 4.0 | 1.79 |
| Characterization | | | | | | | |
| Solids content, % | 18.9 | 19.0 | 18.8 | 19.1 | 19.1 | 19.1 | 17.7 |
| Core/shell ratio | 5.1:1 | 5.1:1 | 5.1:1 | 5.1:1 | 5.1:1 | 5.1:1 | 5.7:1 |
| Wt % Fatty acid | 1.6 | 1.6 | 1.6 | 1.6 | 1.6 | 1.6 | 1.6 |
| B1/B2 ratio | 4.4:5.6 | 4.4:5.6 | 4.4:5.6 | 4.4:5.6 | 4.4:5.6 | 4.4:5.6 | 4.4:5.6 |
| D10, μm | NA | 21.2 | NA | 36.0 | 21.1 | NA | 30.6 |
| D90, μm | NA | 115.0 | NA | 149.0 | 142.3 | NA | 210.6 |
| Wt % Loss (105° C., 24 h) | 2.8 | 6.1 | 7.0 | 14.2 | 5.2 | 1.7 | 11.2 |

In Tables 2 and 3 below, “Solids content” refers to the weight percent of solids in a dispersion of encapsulated PCMs, relative to the weight of the dispersion; “Core/shell ratio” refers to the weight ratio of PCM component to polyurea formed by the reaction of isocyanates with amine; “Wt % Fatty acid” refers to weight percent of fatty acid relative to the weight of fatty acid ester in the sample; “B1/B2 ratio” refers to the weight ratio of aliphatic isocyanate to aromatic isocyanate; “D10” and “D90” refers to D10 and D90 particle size of PCM microcapsules in a dispersion as measured according to the Particle size and distribution of PCM Microcapsules test method described above; “Wt % Loss” refers to percent of weight loss of PCM microcapsules upon heating at 105° C. for 24 hours relative to the weight of the PCM microcapsules (prior to heating), as measured according to the Thermal Stability of Microcapsules test method described above; “NA” means not available.

TABLE 3
Compositions and characterization results of CE 1 to CE 15

| Component | CE 1 | CE 2 | CE 3 | CE 4 | CE 5 | CE 6 | CE 7 | CE 8 | CE 9 |
|---|---|---|---|---|---|---|---|---|---|
| Oil phase mixture | | | | | | | | | |
| Methyl palmitate | 100.0 | 100.0 | 100.0 | 100.0 | 100.0 | 100.0 | 100.0 | 100.0 | 100.0 |
| Decanol | | | | | | | | | |
| Dodecanol | | | | | | | | | |
| Tetradecanol | | | | | | | | | |
| Octadecane | | | | | | | | | |
| IPDI | 6.3 | 6.3 | 6.3 | 6.3 | 6.3 | 6.3 | 6.3 | 6.3 | 6.3 |
| Polymeric MDI | 6.3 | 6.3 | 6.3 | 6.3 | 6.3 | 6.3 | 6.3 | 6.3 | 6.3 |
| CC-1200 | 20.0 | 20.0 | 20.0 | 20.0 | 20.0 | 20.0 | 20.0 | 20.0 | 20.0 |
| 15-S-5 | | 12.3 | | | | | | | |
| 15-S-9 | | | 12.3 | 12.3 | | | | | |
| Palmitic acid | NA | NA | NA | NA | NA | NA | 0.40 | 0.80 | 6.4 |
| Aqueous amine solution | | | | | | | | | |
| DI Water | 600.0 | 600.0 | 600.0 | 600.0 | 600.0 | 600.0 | 600.0 | 600.0 | 600.0 |
| DETA | 4.0 | 4.0 | 4.0 | 4.0 | 4.0 | 4.0 | 4.0 | 4.0 | 4.0 |
| 15-S-5 | | | | 2.0 | | | | | |
| SDBS | | | | 0.14 | | | | | |
| Ammonium palmitate | | | | | 1.7 | | | | |
| Sodium palmitate | | | | | | 1.7 | | | |
| Characterization | | | | | | | | | |
| Core/shell ratio | 6:1 | 6:1 | 6:1 | 6:1 | 6:1 | 6:1 | 6:1 | 6:1 | 6.4:1 |
| Solids content, % | NA | NA | NA | NA | NA | NA | 18.6 | 18.6 | 19.2 |
| Wt % Fatty acid | 0 | 0 | 0 | 0 | 0 | 0 | 0.40 | 0.80 | 6.4 |
| B1/B2 ratio | 5:5 | 5:5 | 5:5 | 5:5 | 5:5 | 5:5 | 5:5 | 5:5 | 5:5 |
| Wt % Loss (105° C., 24 h) | NA | NA | NA | NA | NA | NA | 41.7 | 23.8 | 25.0 |

| Component | CE 10 | CE 11 | CE 12 | CE 13 | CE 14 | CE 15 |
|---|---|---|---|---|---|---|
| Oil phase mixture | | | | | | |
| Methyl palmitate | 100.0 | 100.0 | | | | |
| Decanol | | | 100.0 | | | |
| Dodecanol | | | | 100.0 | | |
| Tetradecanol | | | | | 100.0 | |
| Octadecane | | | | | | 100.0 |
| IPDI | 12.6 | | 6.3 | 6.3 | 6.3 | 6.3 |
| Polymeric MDI | | 12.6 | 6.3 | 6.3 | 6.3 | 6.3 |
| CC-1200 | 20.0 | 20.0 | 20.0 | 20.0 | 20.0 | 20.0 |
| 15-S-5 | | | | | | |
| 15-S-9 | | | | | | |
| Palmitic acid | 1.6 | 1.6 | 1.6 | 1.6 | 1.6 | 1.6 |
| Aqueous amine solution | | | | | | |
| DI Water | 600.0 | 600.0 | 600.0 | 600.0 | 600.0 | 600.0 |
| DETA | 4.0 | 4.0 | 4.0 | 4.0 | 4.0 | 4.0 |
| 15-S-5 | | | | | | |
| SDBS | | | | | | |
| Ammonium palmitate | | | | | | |
| Sodium palmitate | | | | | | |
| Characterization | | | | | | |
| Core/shell ratio | 6:1 | 6:1 | 6:1 | 6:1 | 6:1 | 6:1 |
| Solids content, % | NA | 18.7 | NA | NA | NA | NA |
| Wt % Fatty acid | 1.6 | 1.6 | 1.6 | 1.6 | 1.6 | 1.6 |
| B1/B2 ratio | B1 | B2 | 5:5 | 5:5 | 5:5 | 5:5 |
| | only | only | | | | |
| Wt % Loss (105° C., 24 h) | NA | 29.6 | NA | NA | NA | NA |

1. A composition comprising microcapsules comprising a core and a shell,
wherein the core comprises a phase change material component which comprises:
(A1) a fatty acid ester,
(A2) from 1 to 6 weight percent of a fatty acid having 10 to 18 carbon atoms, based on the weight of the fatty acid ester, and
(A3) 0 to 10 weight percent of a fatty alcohol, based on the weight of the fatty acid ester;
wherein the shell comprises a reaction product of an isocyanate component and an amine compound,
wherein the isocyanate component comprises, based on the weight of the phase change material component, (B1) 1 to 20 weight percent of an aliphatic isocyanate having at least two isocyanate groups, and (B2) 1 to 20 weight percent of an aromatic isocyanate having at least two isocyanate groups; wherein the weight ratio of the aliphatic isocyanate to the aromatic isocyanate is in a range of from 8.5:1.5 to 1.5:8.5; and
wherein the amine compound comprises at least two amino functional groups selected from a primary amino group, a secondary amino group, or combinations thereof; and wherein the amine compound is present in an amount to provide a molar ratio of total primary and secondary amino groups to isocyanate groups in a range of 0.3:1 to 1.5:1.

2. The composition of claim 1, wherein the fatty acid ester (A1) is present at a concentration of from 86 to 99 weight percent, based on the weight of the phase change material component.

3. The composition of claim 1, wherein the fatty acid ester (A1) is selected from the group consisting of methyl palmitate, methyl laurate, methyl stearate, methyl myristate, ethyl laurate, ethyl palmitate, isopropyl stearate, isopropyl palmitate, butyl stearate, butyl palmitate, cetyl palmitate, and mixtures thereof; and the fatty acid (A2) is selected from the group consisting of palmitic acid, lauric acid, stearic acid, myristic acid, decanoic acid, and mixtures thereof.

4. The composition of claim 1, wherein the phase change material component (A) is selected from one of the following (a-i) to (a-vi), wherein
(a-i) the fatty acid ester is methyl palmitate and the fatty acid is palmitic acid,
(a-ii) the fatty acid ester is methyl palmitate, the fatty acid is palmitic acid, and the fatty alcohol is selected from the group consisting of tetradecanol, dodecanol, and mixtures thereof;
(a-iii) the fatty acid ester is methyl laurate and the fatty acid is lauric acid;
(a-iv) the fatty acid ester is methyl stearate and the fatty acid is palmitic acid;
(a-v) the fatty acid ester is ethyl laurate and the fatty acid is lauric acid; and
(a-vi) the fatty acid ester is a mixture of 10 to 100 weight percent of ethyl palmitate and from 0 to 90 weight percent of methyl palmitate, based on the total weight of the fatty acid ester, and the fatty acid is palmitic acid.

5. The composition of claim 1, wherein the aliphatic isocyanate is selected from the group consisting of isophorone diisocyanate, hexamethylene diisocyanate; dimers thereof; trimers thereof; and mixtures thereof; and wherein the aromatic isocyanate is selected from the group consisting of a polymethylene polyphenyl isocyanate, methylene diphenyl diisocyanate, a polycarbodiimide-modified methylene diphenyl diisocyanate, and mixtures thereof.

6. The composition of claim 1, wherein the isocyanate component comprises one of (b-i) to (b-iii):
(b-i) a mixture of isophorone diisocyanate and a polymethylene polyphenyl isocyanate at a weight ratio of isophorone diisocyanate to polymethylene polyphenyl isocyanate in a range of from 3:7 to 7:3,
(b-ii) a mixture of hexamethylene diisocyanate trimer and a polymethylene polyphenyl isocyanate at a weight ratio of hexamethylene diisocyanate trimer to polymethylene polyphenyl isocyanate in a range of 3:7 to 7:3, and
(b-iii) a mixture of isophorone diisocyanate trimer and a polymethylene polyphenyl isocyanate at a weight ratio of isophorone diisocyanate trimer to polymethylene polyphenyl isocyanate in a range of 3:7 to 7:3.

7. The composition of claim 1, wherein the microcapsules have a D90 in a range of 10 to 500 micrometers.

8. The composition of claim 1, wherein the core and/or the shell each independently comprise an inorganic filler present at a total concentration of from 2 to 30 weight percent, based on the weight of the phase change material component.

9. The composition of claim 1, wherein the microcapsules have an average weight ratio of core to shell in a range of from 2.0:1 to 10:1.

10. The composition of claim 1, wherein the microcapsules comprise less than 0.1 weight percent of an emulsifier, based on the weight of the microcapsules.

11. A method of preparing the composition comprising microcapsules of claim 1, comprising:
(I) providing an oil phase mixture comprising:
(A) a phase change material component comprising:
(A1) a fatty acid ester,
(A2) from 1 to 6 weight percent of a fatty acid having 10 to 18 carbon atoms, based on the weight of the fatty acid ester, and
(A3) 0 to 10 weight percent of a fatty alcohol, based on the weight of the fatty acid ester;
(B) an isocyanate component comprising, based on the weight of the phase change material component, (B1) 1 to 20 weight percent of an aliphatic isocyanate having at least two isocyanate groups, and (B2) 1 to 20 weight percent of an aromatic isocyanate having at least two isocyanate groups; wherein the weight ratio of the aliphatic isocyanate to the aromatic isocyanate is in a range of from 8.5:1.5 to 1.5:8.5;
(II) providing an aqueous amine solution comprising an amine compound and water, wherein the amine compound comprises at least two amino functional groups selected from a primary amino group, a secondary amino group, or combinations thereof; and wherein the amine compound is present in an amount to provide a molar ratio of total primary and secondary amino groups in the amine compound to total isocyanate groups in the isocyanate component in a range of 0.3:1 to 1.5:1;
(III) adding the oil phase mixture to the aqueous amine solution under stirring to form a reaction mixture; and
(IV) maintaining the reaction mixture obtained from step (III) for a period of time until the microcapsules are obtained.

12. The method of claim 11, wherein the amine compound is selected from the group consisting of diethylenetriamine, 1,3,5-cyclohexanetriamine, 1,2,3-propanetriamine, and mixtures thereof.

13. The method of claim 11, wherein the oil phase mixture further comprises, based on the weight of the phase change material component, from 2 to 30 weight percent of an inorganic filler.

14. The method of claim 11, wherein stirring in step (III) is conducted at a rate of less than 1500 revolutions per minute.

15. The method of claim 11, wherein the method is conducted in the absence of a step of emulsifying the oil phase mixture using an emulsifier.
